(19) United States
(12) Patent Application Publication
(10) Pub. No.: US 2008/0099166 A1
(43) Pub. Date: May 1, 2008

(54) Crime Prevention Structure for Guide Rail of Shutter for Building

(76) Inventors: Hiroaki Ichiyanagi, Tokyo (JP); Atsushi Mori, Tokyo (JP)

Correspondence Address: LADAS & PARRY, 5670 WILSHIRE BOULEVARD, SUITE 2100, LOS ANGELES, CA, 90036-5679, US

(21) Appl. No.: 11/661,587

(22) PCT Filed: Sep. 9, 2004
(86) PCT No.: PCT/JP04/13103

§ 371 Date: Apr. 9, 2007

(51) Int. Cl. E06B 9/17; E06B 9/15; E06B 9/58

(52) U.S. Cl. 160/266

(57) ABSTRACT

The present invention relates to a guide rail structure with which it is difficult to remove a slat from a guide rail using a bar or the like. In a guide rail having an outdoor sidewall, an opening side front wall, and a guide groove formed in said opening side front wall, a pocket space is formed in an indoor side of a slat end portion received in the guide rail and the pocket space permits deformation of said slat end portion towards an indoor side, a dimension of the pocket space is made larger than a width dimension of the guide groove, and said outdoor sidewall of the guide rail is set to a larger bending strength than the slat end portion, wherein when a force enlarging a gap between the outdoor sidewall and the slat end portion acts upon the outdoor sidewall and the slat end portion, the slat end portion is caused to deform in the pocket space before the outdoor sidewall deforms such that removal of the slat end portion from the guide groove is prevented by engaging the opening side front wall with the slat end portion that has been deformed in the pocket space.

### TECHNICAL FIELD

The present invention relates to a crime prevention structure of a shutter for a building, and more particularly relates to a crime prevention structure for a guide rail.

### BACKGROUND ART

Recently, there have been occurrences of crimes such as opening up an opening of a building and breaking in to rooms by breaking a guide rail using a bar, for example, and removing shutter slats from the guide rail.

Forcibly open of a guide rail using a bar is shown in FIG. 4. According to the guide rail of FIG. 4, an upper side corresponds to an outdoor side, and a lower side corresponds to an indoor side. A bar Ba is forced in between a sidewall 10 of the outdoor side of the guide rail and the shutter slat 30 from the outdoor side. If the tip of the bar Ba is brought into contact with the corner inside the guide rail, and the bar Ba is rotated with the tip as a fulcrum, then a contact point of the bar Ba and the outdoor side wall 10 of the guide rail becomes a fulcrum, and the slats 30 is taken out by pulling the outdoor sidewall 10.

### DISCLOSURE OF THE INVENTION

The present invention has been conceived in order to solve the disadvantages of the related art guide rail, and an object of the present invention is to provide a guide rail structure with which it is difficult to remove a slat from a guide rail using a bar or the like.

According to the present invention, in a guide rail having an outdoor sidewall, an opening side front wall, and a guide groove formed in said opening side front wall, a pocket space is formed in an indoor side of a slat end portion received in the guide rail and the pocket space permits deformation of said slat end portion towards an indoor side, a dimension of the pocket space is made larger than a width dimension of the guide groove, and said outdoor sidewall of the guide rail is set to a larger bending strength than the slat end portion, wherein when a force enlarging a gap between the outdoor sidewall and the slat end portion acts upon the outdoor sidewall and the slat end portion, the slat end portion is caused to deform in the pocket space before the outdoor sidewall deforms such that removal of the slat end portion from the guide groove is prevented by engaging the opening side front wall with the slat end portion that has been deformed in the pocket space.

Conventionally, as a countermeasure against the forcibly open of a guide rail, it has generally been considered to make the strength of the guide rail and the slat end portion large, so that deformation of the guide rail and slat end portion would not occur. The present invention is based on an inherently different technical idea than this type of countermeasure, and has a crime prevention function imparted to a guide rail by permitting deformation of slat end portion and by making it difficult to remove the deformed slat from the guide rail. In order to achieve this, it becomes necessary to provide “a space in which slat end portion can deform”, and “a structure such that when a force that enlarges a gap between the outdoor sidewall and the slat end portion acts upon the guide rail and the slat end portion as a result of turning of a bar or the like, the slat end portion deforms but the guide rail does not”. A pocket space is formed at an indoor side section of a guide rail internal space that permits deformation of the slat end portion towards the indoor side and has a depth dimension that is larger than the width of the guide groove. Also, the strength of the guide rail body is set to such a strength that the slat end portion deforms first when a force for enlarging the gap between the outdoor sidewall and the slat end portion acts (Specifically, the bending strength of the outdoor sidewall is larger than the bending strength of the slat end portion).

An opening side of the pocket space is defined by an opening side front wall of the guide rail (positioned at an indoor side of the guide rail groove or the slat), and by engaging slat end portion that has been deformed inside the pocket space with the indoor side front wall of the guide rail, the slat end portion remains in the indoor side space and is difficult to be removed.

According to a preferred aspect, at least the outdoor sidewall of the guide rail body is formed as a thickened portion so that strength is imparted to the guide rail body to counteract a force in a direction to open the sidewall. More preferably, a bottom wall integrally formed with the outdoor sidewall at a base end thereof is also formed as a thickened portion.

According to another preferred aspect, by providing a piece that is curved or diagonal in plan view at a section of the guide rail internal space positioned at a bottom side and an indoor side of the space (with this specification, a bottom side refers to a side of a guide rail away from an opening), a corner section is not formed in that section. In this way, the corner section that could normally provide a fulcrum for the tip of a bar is eliminated from the indoor side and bottom side section of the guide rail space. With an example that will be described later, the curved piece is provided in the indoor side and the bottom side section of the guide rail internal space so as to devoid the indoor side and the bottom side section of a section that would provide a fulcrum for a bar with a tip end thereof being engaged to.

According to another preferred aspect, a thinned portion is formed close to an end section of the opening side of the outdoor sidewall of the guide rail, and if a force acts on the outdoor sidewall, the sidewall bends at the thinned portion. In this manner, if an attempt is made to pull out the whole of the outdoor sidewall of the guide rail, only the tip section of the sidewall bends before the entire sidewall is pulled out, and it is therefore made difficult to pull out the whole sidewall.

If a force in a direction to open the outdoor sidewall of the guide rail body is applied as a result of turning a bar, for example, inserted into the groove section of the guide rail from the outdoor side, the bar also contacts the slat end portion, which means that a force to deform the slat end portion towards the indoor side is also applied to the slat end portion. Because a space sufficient to permit deformation of the slat end portion is provided at an indoor side of the slat end portion and because bending strength such that the slat end portion deforms first is imparted to the guide rail body (the outdoor sidewall), the slat end portion can deform in the pocket space provided at an indoor side of the slat end portion. The depth dimension of the pocket space is set larger than the width dimension of the guide groove, and the slat end portion is sufficiently deformable so that it is difficult to take the slat end portion out from the guide rail groove. An opening side of the pocket space is defined by an opening side front wall of the guide rail, and slat end portion that have been deformed in the pocket space engages the indoor side front wall of the guide rail. Accordingly, the deformed slat end portion remains in the pocket space, and it is difficult to take out the slat end portion with a bar or the like.

### BRIEF DESCRIPTION OF THE DRAWINGS

FIG. 1 is a front elevation of a shutter device;

FIG. 2 shows cross sectional drawings of a guide rail of the present invention;

FIG. 3 is a drawing for describing operation of the present invention, using the guide rail of the other embodiment of the invention;

FIG. 4 is a drawing for describing the taking out of end section of slat using a bar, in a related art guide rail structure;

FIG. 5 is an overall front elevation of a shutter device seen from an indoor side;

FIG. 6A is a front view of a locking mechanism in an unlocked state;

FIG. 6B is a side view of a locking mechanism in an unlocked state;

FIG. 6C is a front view of a locking mechanism in a locked state;

FIG. 6D is a side view of a locking mechanism in a locked state;

FIG. 7A is a cross sectional drawing showing a positional relationship between a guide rail, slats and a locking mechanism in normal operation;

FIG. 7B is a vertical sectional view showing a positional relationship between a guide rail, slats and a locking mechanism in normal operation;

FIG. 7C is a front view showing a positional relationship between a guide rail, slats and a locking mechanism in normal operation;

FIG. 8A is a cross sectional drawing showing a positional relationship between a guide rail, slats and a locking mechanism in a locked state;

FIG. 8B is vertical sectional view showing a positional relationship between a guide rail, slats and a locking mechanism in a locked state;

FIG. 8C is a front view showing a positional relationship between a guide rail, slats and a locking mechanism in a locked state;

FIG. 9A is a cross sectional drawing showing a positional relationship between a guide rail, slats and a locking mechanism, in the case where slats are deformed in a locked state;

FIG. 9B is cross sectional view showing a positional relationship between a guide rail, slats and a locking mechanism, in the case where slats are deformed in a locked state;

FIG. 10A is a cross sectional view showing a positional relationship between an engagement projection piece constituting a projecting body at an edge that does not have an oblique edge, and a guide rail forced open with a bar;

FIG. 10B is a cross sectional drawing showing a positional relationship between an engagement projection piece of the present invention constituting a projecting body at an edge that has an oblique edge, and a guide rail forced open with a bar;

FIG. 11 is a sectional view of a slat;

FIG. 12 is an enlarged sectional view showing an interlocking joint section;

FIG. 13 is a sectional view of a slat; and

FIG. 14 is an enlarged sectional view showing an interlocking joint section.

### BEST MODE FOR CARRYING OUT THE INVENTION

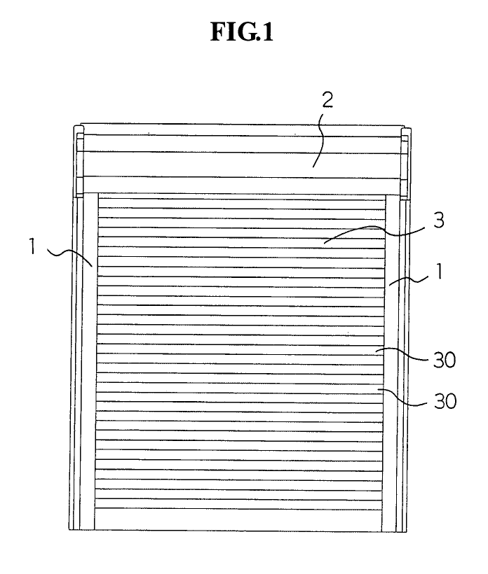

FIG. 1 is a front elevation of a shutter device, and the shutter device has upstanding left and right guide rails 1 provided at left and right end sections of a building opening, a shutter case 2 provided above the opening, and a shutter curtain 3 that opens and closes the opening. The shutter curtain 3 is formed by vertically linking a plurality of slats 30, with an upper end of the shutter curtain 3 being connected to a winding shaft, not shown, that is horizontally provided inside the shutter case 2, and the shutter curtain being wound around the winding shaft when the opening is opened. When closing the opening, the shutter curtain is unwinding from the winding shaft, and the opening is closed up by lowering the shutter curtain 3 with both end sections of the slats 30 being guided in the left and right guide rails 1.

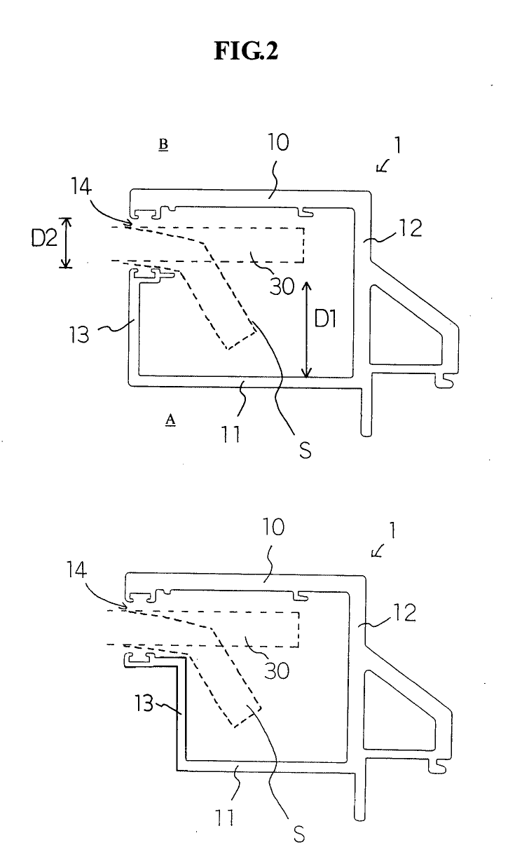

The upper diagram in FIG. 2 is a cross sectional view of a guide rail of the present invention, and in the drawing the upper side is an outdoor side B, and the lower side is an indoor side A. The body of the guide rail 1 is integrally comprised of an outdoor sidewall 10, an indoor sidewall 11, a bottom wall 12 extending in a direction orthogonal to the side walls 10 and 11, and a front wall 13 positioned at an opening side. Bottom side end sections of the outdoor sidewall 10 and the indoor sidewall 11 are connected by the bottom wall 12. The opening side front wall 13 extends from an opening side tip end of the indoor sidewall 11 towards an opening side tip end of the outdoor sidewall 10, and a groove section 14 as a slat receiving aperture for receiving end sections of the slats 13 is formed in the opening side front wall 13. Specifically, the opening side front wall 13 is shorter than the bottom wall 12, and the groove section 14 is formed between the opening side front wall 13 and an opening side tip end part of the outdoor sidewall 10. The opening side front wall 13 is an indoor side front wall positioned at an indoor side of the guide rail groove section 14 or the slat 30. The groove section 14 communicates with an internal space defined by the guide rail body, and is constructed so that when the opening is closed, end sections of slats of the shutter curtain are received in the internal space through the groove section 14.

In the internal space of the guide rail 1, an indoor side space, which is positioned at an indoor side of the slat 30 that has been received in the internal space and opposite to the slat end portion, forms a pocket space S for permitting deformation of the slat end portion to the indoor side. The pocket space S has a shape and depth for permitting deformation of the end section of the slat 30 to the indoor side. Specifically, a depth dimension D1 of the pocket space S in the width direction of the guide groove 14 is larger than a width dimension D2 of the guide groove 14.

The guide rail body has sufficient strength such that when an elongated body (for example, a bar) extending between the guide rail outdoor sidewall 10 and the end portion of the slat 30 is forced into the guide groove 14 from the outdoor side and turned in a direction to forcibly open the outdoor sidewall 10 to the outdoor side, the guide rail body resists the force in the opening direction and the slat end deforms in the pocket space S before the outdoor sidewall 10 does. Specifically, the bending strength of the outdoor sidewall 10 of the guide rail is set larger than the bending strength of the slat end portion, so that when a force to enlarge the gap between the outdoor sidewall 10 and the slat end portion acts, the slat end portion deforms in the pocket space S before the outdoor sidewall 10 does. Specifically, the outdoor sidewall 10 and the bottom wall 12 are formed as thickened portions that are thicker than the opening side front wall 13, strength is imparted to the outdoor side wall 10, the bottom wall 12 and a section that connects the walls 10 and 12 so as to resist a force in a direction that open the outdoor sidewall 10 to the outdoor side. It is made difficult for the outdoor sidewall 10 to be pulled away from the bottom wall 12. The structure for imparting strength to the outdoor sidewall 10 of the guide rail body is not limited to that shown in the drawings, and it is also possible to thicken the guide rail body, provide a reinforcing member on the guide rail body, or form the guide rail from a more rigid material.

In FIG. 2, if an attempt is made to take out the slat 30 by inserting a bar, not shown, into a groove section 14 of the guide rail (between the outdoor sidewall 10 of the guide rail 1 and the slats 30) from the outdoor side B and rotating the bar in a direction to open out the outdoor sidewall 10 where the bar is in contact with the outdoor sidewall 10 and the slat 30, the outdoor sidewall 10 of the guide rail body resists the force in the opening direction (even if the sidewall opens to a certain extent, the sidewall restores to its original shape due to rigidity). On the other hand, the slat 30 contacts the tip of the opening side front wall 13 of the guide rail 1 and is bent to the inside of the pocket space S with the point of contact as a fulcrum.

The pocket space S forms a space for preventing removal of the deformed slats. An opening side section of the pocket space S is defined by the guide rail indoor side front wall 13 facing the opening, and an opening side of the indoor sidewall 11. As described above, if a bar is inserted into the guide rail groove section 14 from the outdoor side and the force towards the indoor side acts on the end section of the slat, the end section of the slat 30 is deformed in the pocket space S. If there is a further attempt to take the slat end portion out of the guide rail, a bent section of the deformed slat end portion engages the opening side front wall 13 of the guide rail 1 and the deformed slat end portion remains in the pocket space S. Furthermore, because the depth dimension of the pocket space S is larger than the width dimension of the guide groove 14, the slat end portion is deformed by an extent sufficient to make it difficult to remove it from the guide groove 14. Specifically, as shown in FIG. 2, with the bent slat end portion, it becomes difficult to remove the slat end from the guide groove 14 and it remains in the pocket space S. The slat end portion does not necessarily have to be bent to such an extent that it is caught by the opening side front wall 13 at the time of bending. If the amount of deformation of the bent slat end portion is larger than the width dimension D2 of the guide groove 14, then if an attempt has been made to remove the slat end portion from the guide rail, the bent slat end portion moves to the groove 14 side, and the bent slat end portion is caught by the opening side front wall 13 and pulling out of the slat end portion from the guide rail is prevented. Also, in order to sufficiently deform the slat end portion and prevent the slat end portion being pulled out from the guide rail, it is preferable to make the dimension of the slat end portion that is received inside the guide rail internal space larger (the slat end portion is received deeply in the internal space).

A guide rail structure that embodies the present invention is not limited to that shown in the upper part of FIG. 2, and it is also possible to have a shape as shown in the lower part of FIG. 2. In the lower part of FIG. 2, the indoor sidewall 11 is formed shorter than the outdoor sidewall 10, and compared to the arrangement in the upper part of FIG. 2, the indoor side front wall 13 is offset to the bottom side (bottom wall 12 side).

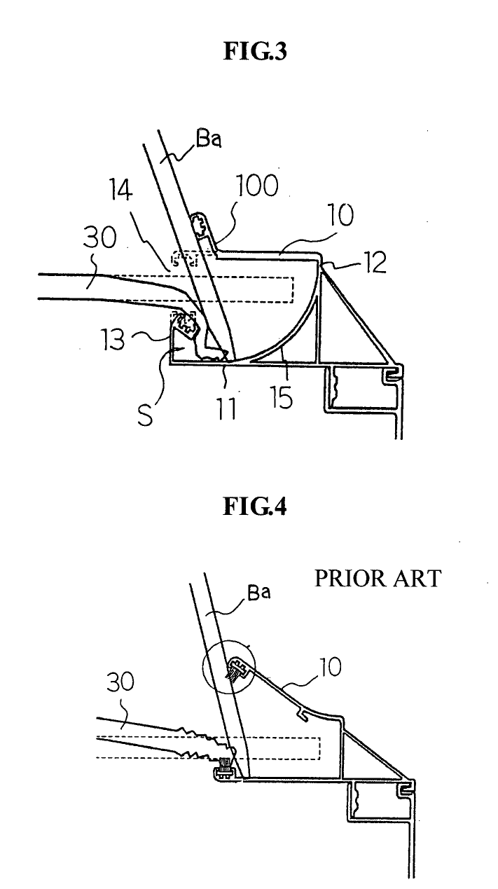

FIG. 3 shows another embodiment of a guide rail structure of the present invention. According to the embodiment shown in FIG. 3, two measures for preventing removal of the slat are disclosed. One is to devoid a guide rail of a section to which the tip of a bar can be engaged, and the other is to decrease the strength of a section that becomes a fulcrum when a bar or the like is used as a lever, making it difficult to open the guide rail. In FIG. 3, a structure adopting both of the two measures is shown, but the two measures are independent means, and can be independently adopted in a guide rail. A specific explanation will be given in the following. Similarly to FIG. 2, an upper side is an outdoor side, and a lower side is an indoor side. The guide rail 1 is integrally comprised of an outdoor sidewall 10, an indoor sidewall 11, a bottom wall 12 and an opening side front wall 13. Base end sides of the outdoor sidewall 10 and the indoor sidewall 11 are connected by the bottom wall 12. The opening side front wall 13 extends from an opening side tip end of the indoor sidewall 11 towards an opening side tip end of the outdoor sidewall 10, the opening side front wall 13 is shorter than the bottom wall 12, and a groove section 14 as a slat receiving aperture for receiving end sections of the slats is formed between the opening section side front wall 13 and the opening section side tip end section of the outdoor sidewall 10.

A curved piece 15 for covering a corner section formed at a connection of the indoor sidewall 11 and the bottom wall 12 is provided inside the guide rail. The curved piece 15 is integrally formed with one end at close to an outdoor side end section of the bottom wall 12 and the other end at a substantially central part of the indoor sidewall 11, and is gently curved so as to expand towards the corner section. Instead of providing the indoor sidewall 11 and the bottom wall 12, it is also possible to construct the guide rail by connecting a bottom side end section of the outdoor sidewall 10 and an indoor side end section of the opening side front wall 13 with an arc-shaped curved piece.

A thinned portion 100 is formed in the vicinity of an opening side end section of the outdoor sidewall 10, and is constructed so that if a force intended to open the outdoor sidewall 10 acts, then the outdoor sidewall 10 bends at the thinned portion 100.

With the guide rail formed in this way, even if a bar Ba is forced between the outdoor sidewall 10 of the guide rail and the shutter slat 30 from the outdoor side, a corner section serving as a fulcrum for the bar Ba is concealed by the curved piece 15, and also, the curved piece 15 provides a curved surface, and there is no engagement in the inner space of the guide rail to give a fulcrum for the bar Ba, and so opening out of the outdoor sidewall 10 of the guide rail 1 by the bar Ba is made difficult. Further, since the thinned portion 100 of the outdoor sidewall 10 is easily bent, when a bar Ba is turned, a force acts on the tip end side of the outdoor sidewall 10 and only the tip section of the outdoor sidewall will bend, and it is difficult to pull the entire sidewall 10.

In the internal space of the guide rail 1 of FIG. 3, a section, which is positioned at an indoor side of the slats 3 and opposite to the slat end, forms a pocket space S for permitting deformation of the slat end portion 30 to the indoor side. In FIG. 3, if a bar is inserted from the outdoor side into a groove section 14 of the guide rail (a gap between the outdoor sidewall 10 of the guide rail 1 and the slat 30) and an attempt is made to take out the slat 30 by turning the bar, the slat 30 contacts the tip end of the opening side front wall 13 of the guide rail 1 and is bent towards the inside of the pocket space S with the point of contact as a fulcrum.

An opening side section of the pocket space S is defined by the guide rail indoor side front wall 13 facing the opening and an opening side of the indoor sidewall 11. As described above, if a bar is inserted into the guide rail groove section 14 from the outdoor side and a force towards indoor side acts on the end section of the slat and the end section of the slat 30 is deformed in the pocket space S. If there is a further attempt to remove the slat 30 from the guide rail, a bent portion of the deformed slat end portion is engaged to the opening side front wall 13 of the guide rail 1 and the deformed slat end portion remains in the pocket space S. The more effort is put into taking out the slat with the bar Ba, the more the slat will deform, and the more the tip end section of the opening side front wall 13 will deform, making it more difficult to take out the slat end portion.

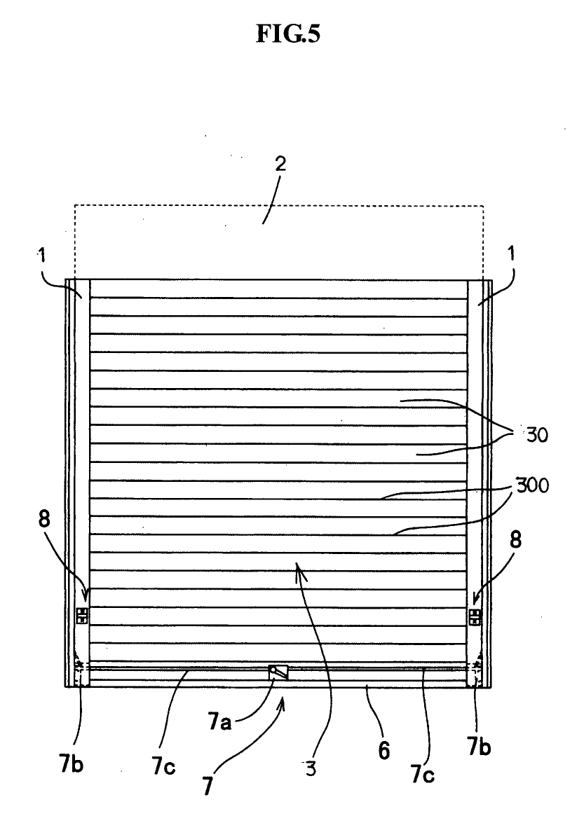

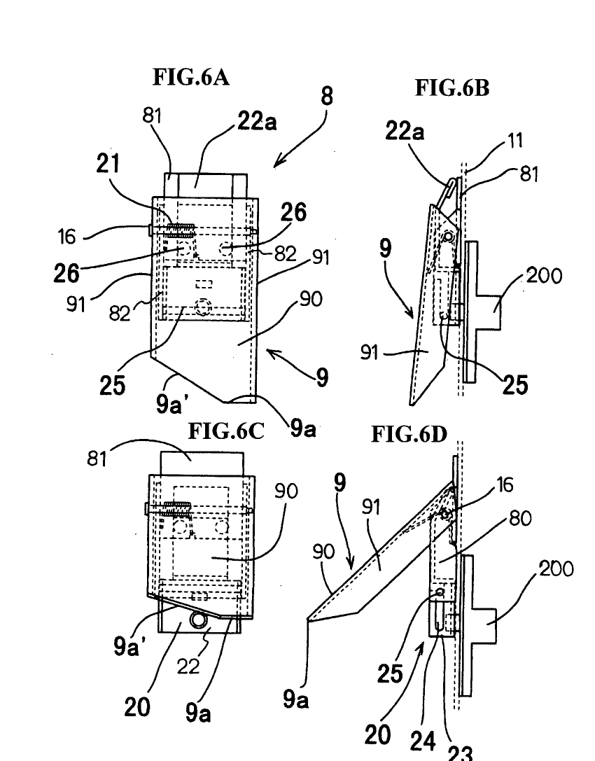

A crime prevention structure for a guide rail has been described, but in improving the crime prevention functionality of the entire shutter assembly, it is preferable to provide a locking device for locking the shutter curtain when the opening is completely closed. A shutter locking device will be described based on FIG. 5 through FIG. 10. The locking device comprises a first locking device 7 and a second locking device 8. The first locking device 7 comprises a locking operation section 7a provided in a bottom plate 6 positioned at a lower end of the shutter curtain 3, a locking rod 7c that is moveable into and out of the guide rail 1, and latch hooks 7b provided at the lower ends of the guide rails 1. When the opening is fully closed, the locking rod 7c is caused to project into the guide rails 1 by means of the locking operation section 7a, and engages the latch hooks 7b.

The second locking device 8 is mounted at an intermediate section of the guide rail 1. The second locking device 8 has an engagement projection piece 9 provided at an inner surface of the indoor side wall 11 positioned at the indoor side, of the opposed side walls 10, 11 forming the guide groove 14, and the engagement projection piece 9 projects from the inner surface of the sidewall 11 to the inner surface of the outdoor sidewall 10. The engagement projection piece 9 projects towards the inner surface of the outdoor sidewall 10 by a closing operation from the indoor side, and upward movement of the shutter curtain when the opening is completely closed is prevented by engaging the tip section 9a of the engagement projection piece 9 with an interlocking section 300 of the shutter curtain that is received inside the guide rails 1. The first locking device 7 used in combination with the second locking device 8 is not limited to that shown in the drawing, and the second locking device 8 can also be constructed as an independent locking device.

The second locking device 8 is comprised of a planar engagement projection piece 9 and base 80, and a switch 20 that slides with respect to the base 80. The base 80 is fixed in an upright manner to the inner surface of the sidewall 11 positioned at an indoor side of the guide rail 1. An upper side of the engagement projection piece 9 is rotatably supported in the base 80. Further, the engagement projection piece 9 is rotatably urged towards the outdoor sidewall 10 by a coil spring 21 provided between the base 80 and the engagement projection piece 9. A tip end of the switch 20 is brought into contact with a rotating base end side of the engagement projection piece 9 by an upward sliding operation of the switch 20 with respect to the base 80, and the engagement projection piece 9 is moved downward against the urging force of the coil spring 21. With a downward sliding operation of the switch 20, the tip end of the switch 20 moves away from the rotating base end side of the engagement projection piece 9, the engagement projection piece 9 is rotated to the opposite sidewall 10 side by the urging force of the spring 21, and a tip end section 9a of the engagement projection piece 9 is engaged from above to the interlocking section 300.

The base 80 comprises a planar body 81, and opposed and spaced rising surfaces 82 formed at side edges of the body 81. The engagement projection piece 9 comprises a planar projecting body 90, and opposed and spaced reinforcement surfaces 91 formed at side edges of the projecting body 90. A support shaft 16 is horizontally provided between the opposed rising surfaces 82 and reinforcement surfaces 91. The switch 20 is provided between the rising surfaces 82 of the base 80, and slides upward and downward along the rising surfaces 82. The switch 20 comprises a body 22, opposed and spaced sliding guide surfaces 23 formed at edges of the body, and guide grooves 24 formed in the siding guide surfaces 23, with a tip end section 22a being integrally formed at an upper end of the body 22. An edge 9a having an oblique edge 9a′ is formed in the projecting body 90 of the engagement projection piece by cutting out the tip end side. The engagement projection piece 9 has an edge 9a side that rotates with the support shaft 16 as a fulcrum. With the attached drawings, description has been given of a second locking device 8 provided at the right guide rail 1, but according to the second locking device 8 provided at the left guide rail 1, the projecting body 90 merely appears left-right symmetrical.

The coil spring 21 is coaxial with the support shaft 16, and is held between the engagement projection piece 9 and the base 80. Reference numeral 25 designates a guide shaft provided parallel to the support shaft between the base 80 and the rising surfaces 82. The second locking device 8 is attached to an inner surface of the sidewall 11 positioned at an indoor side at an intermediate section of the guide rail 1 by means of attachment holes 26, 26 formed in the body 81 of the base 80. A switch button 200 is fixed to the switch 20 from the indoor side A by means of specified section (not shown) of the sidewall 11 that has been cut out in the vertically movable range of the switch 20.

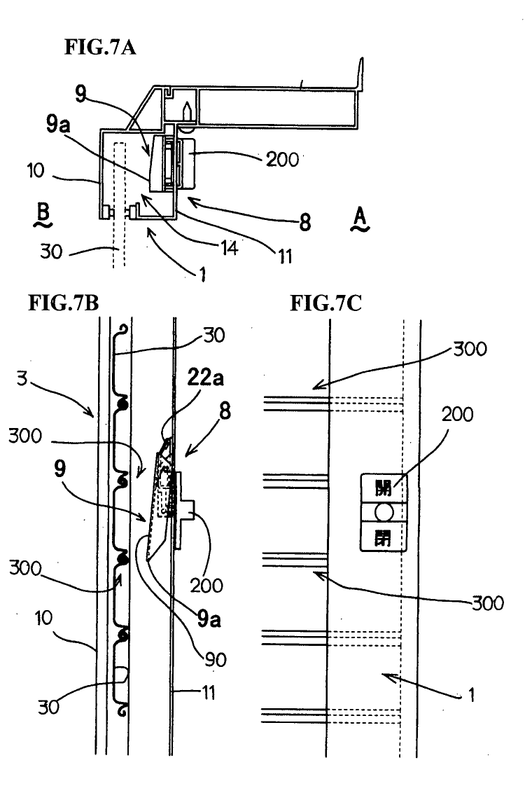

In a normal opening and closing of the shutter curtain 1, as shown in FIG. 7, the second locking device 8 is held in the “open” state with the switch button 200 pushed upwards, the tip section 22a of the switch 20 presses the rear surface of the rotating base end side of the projecting body 90 constituting the engagement projection piece 9, and accordingly the engagement projection piece resisting the urging force of the coil spring 21 is put into an unlocked posture where it does not project to the shutter curtain 3 side. As a result, there is no hindrance to the normal opening and closing operations of the shutter curtain being rising and lowered in the guide rails.

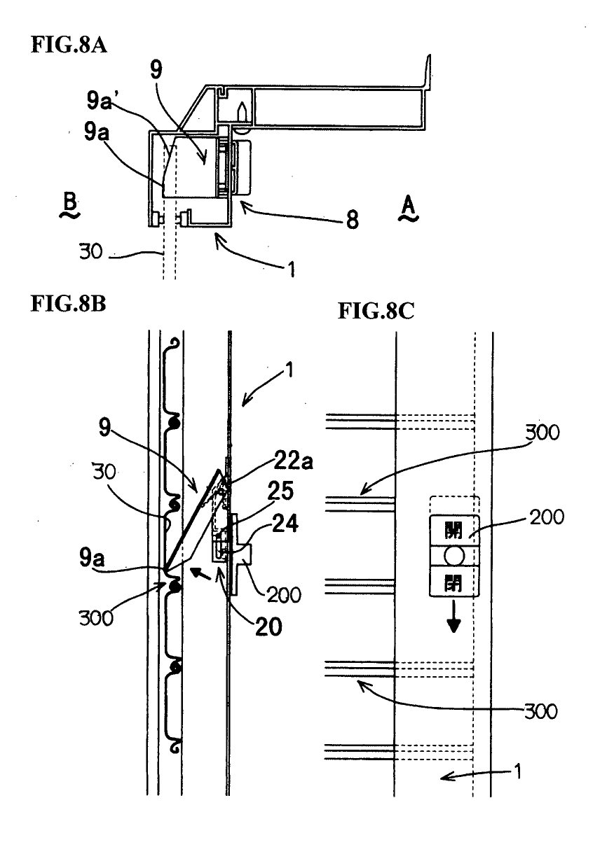

In the event that locking is performed with the shutter curtain fully closed, then as shown in FIG. 8, together with locking of the first locking device 7 provided on the bottom plate 6, the switch button 200 of the second locking device 8 provided in the guide rail 1 is pressed down to switch to the “closed” position. At this time, the switch 20 is also moved downwards being guided on the rising surfaces 82 of the base 80, by downward movement of the switch button 200, and if the tip end section 22a of the switch 20 is moved downward, contact of the engagement projection piece 9 with the rear surface of the rotating end side surface is released, and the engagement projection piece rotates in the direction of the arrow towards the opposing sidewall 10 side under the urging force of the coil spring 21, with the support shaft 16 as a fulcrum. Then, the edge 9a of the engagement projection piece 9 is brought into contact with a rear surface of an upper slat 30 in the vicinity of the interlocking section 300 between the upper and lower slats 30 positioned adjacent to the second locking device 8, and the second locking device 8 is held in the locked state.

With respect to the shutter device that has been put into the locked state using the first locking device 7 and the second locking device 8, even if the first locking device 7 is destroyed by inserting a bar or crowbar or the like into a gap between the bottom plate 6 and the lower frame, when an attempt is made to lift up the fully closed shutter curtain 3, the edge 9a of the engagement projection piece 9 that is in contact with the rear surface of the upper slat 30 positioned close to the second locking device 8 is engaged from above to the interlocking section 300 of the lower slat 30, and in spite of an attempt to lift up the shutter curtain 3, the shutter curtain 3 is kept in the closed state.

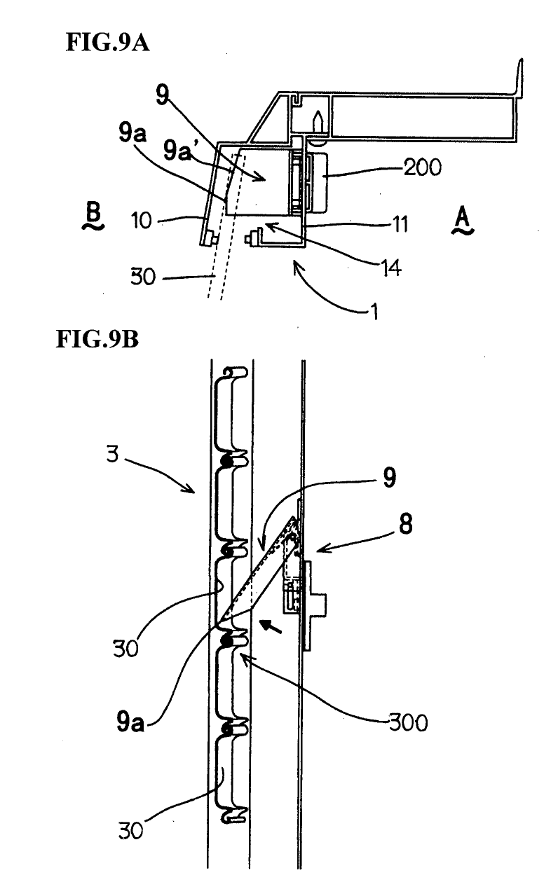

Further, as shown in FIG. 9, when an attempt is made to lift up the shutter curtain 3 while the bottom plate 6 is pulled to the outdoor side B, and the shutter curtain 3 is bulging to the outdoor side B, the edges 9a having the oblique edges 9a′ formed by cutting out edges 9a of the engagement projection pieces 9 are engaged to the interlocking sections 300 at both end sections of the shutter curtain 3. The engaged state is constantly held by the urging force towards the slats 30 side by the coil spring 21, and so it is impossible to release the engaged state.

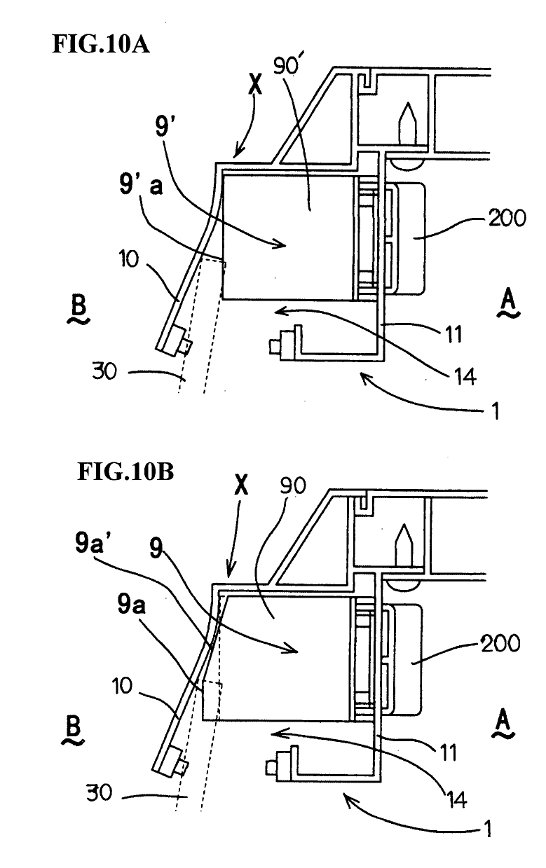

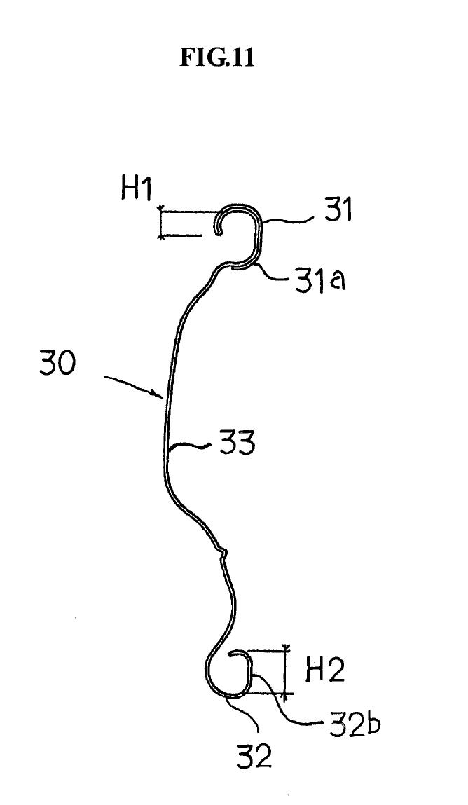

Here, by having an engagement projection piece 9′ constituting a projecting body 90′ with an edge 9′a that does not have an oblique edge 9a′, as shown in FIG. 10(a), if the sidewall 10 of the guide rail 1 is opened out with a bar or the like, the edge 9′a comes into contact with an inner surface of the opposite sidewall 5b in the vicinity of the corner X of the bottom section side of the guide rail 1 and rotation of the engagement projection piece 9′ beyond that is restricted, and there is a potential problem of the edge 9′a not being engaged to the interlocking section 2b of the shutter curtain 3 that has been bowed outward as a result of being pulled to the outdoor side B. With this embodiment, as shown in FIG. 10(b), because of the existence of the oblique edge 9a′ it is possible to ensure “escape” for the above described restriction, and it is possible to reliably implement a locked state of the engagement projection piece 9 with the interlocking section 300 by sufficiently rotating the engagement projection piece 9 to the outdoor side.

A locking device has been described as a crime prevention device, but in order to further improve a crime prevention structure for a shutter, it is effective to endow the slats 30 constituting the shutter curtain 3 with crime prevention characteristics. A connection structure for slats having a superior crime prevention performance will be described based on FIG. 11 to FIG. 14. Slats 30 are formed by roll forming a strip, and at both upper and lower ends of the slat, curved upper side interlocking sections 31 and lower side interlocking sections 32 are formed for interlocking connection of the slats. The upper interlocking section 31 is formed as an upwardly curved portion at an upper end of the slat body 33 and a tip end section thereof is downwardly directed. The lower interlocking section 32 is formed as a downwardly curved portion at a lower end of the slat body 33 opposite to the curving direction of the upper interlocking section 31 and a tip end of an upright section 32b is slightly downwardly directed. An overlapping curved structure where the thin plates forming the slats 30 are laminated is formed by providing a folded portion 31a over almost the whole of the interlocking section 31 by folding back the end of the upper interlocking section 31 along the curved section.

A vertical length H1 of the end section of the upper interlocking section 31 (distance between the top of the upper interlocking section 31 and the inner surface of the curved section) is set shorter than a vertical length H2 of the lower interlocking section 32 (distance between the bottom of the lower interlocking section 32 and the inner surface of the curved section).

When the overlapping curved section is formed at the upper interlocking section 31, there is no need to form it over the entire upper interlocking section 31 as shown in the above described embodiment, and it is possible to form at least as far as a curved section positioned on a substantially vertical line from a tip end of the interlocking section 31.

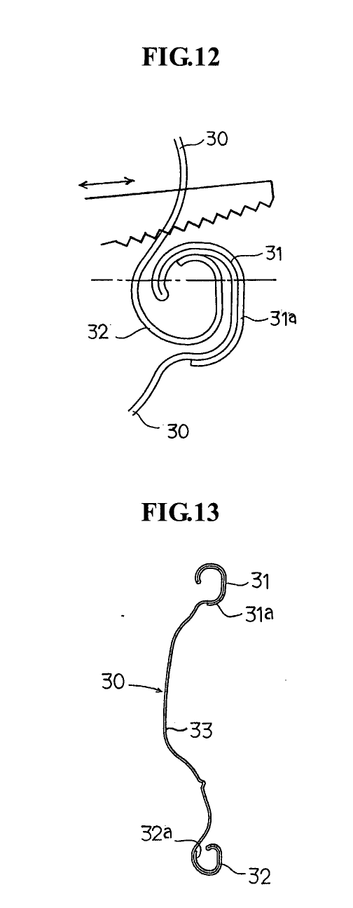

A plurality of the slats 30 are interlocked together to form a shutter curtain, and if the slats 30 are cut in the vertical direction using a cutting tool, it takes a lot of time and effort in a cutting operation due to the overlapped section where the plates are laminated. Specifically, in the interlocking joint section shown in FIG. 12, in the case of cutting as far as the dotted line section, it is necessary to cut through six steel plates in the horizontal direction, starting from a vertical three-layered section, which is advantageous from the point of view of crime prevention. Also, the increase in weight of the shutter curtain overall is only slight as only the interlocking sections are reinforced, and an increase in effort required for the opening and closing operations is also only slight, and the ability of the slats to withstand wind pressure is also improved. When the shutter curtain 3 opens and closes a building opening by being wound and unwound around a winding drum, an upper slat 30 of the vertically adjacent two slats rotates relative to the lower slat 30. An upper inner surface of the interlocking section of the lower slat is supported by an upper outer surface of the interlocking section of the upper slat, and grazing of the inner surface of the lower interlocking section is avoided.

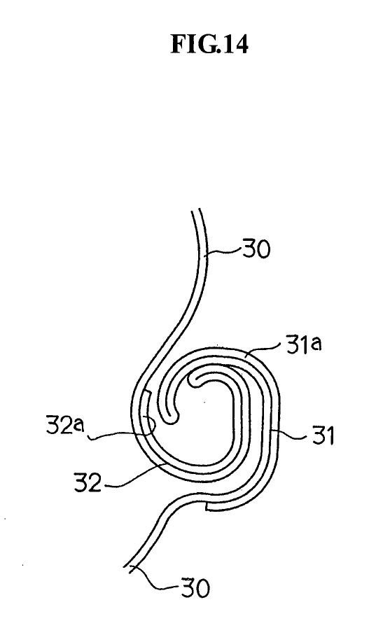

The slats of the present invention are not limited to those of the above described embodiment, and it is also possible to form only the lower interlocking section 32 in an overlapping curved shape (a folded piece 32a), or to form both the upper and lower interlocking sections 31 and 32 in overlapping curved shapes (FIG. 13, FIG. 14), and in this case crime prevention is even better because it is necessary to cut through more steel plates.

### INDUSTRIAL UTILIZATION

According to the present invention, it is possible to prevent forcibly opening of guide rail and removal of slat end portion without carrying out significant reinforcing of a shutter device, thus endowing a shutter device with improved crime-prevention characteristics.

1. A crime prevention structure for a guide rail, said structure comprising:
a guide rail having an outdoor sidewall, an opening side front wall, and a guide groove formed in said opening side front wall; and
a pocket space being formed in an indoor side of a slat end portion received in the guide rail and said pocket space permitting deformation of said slat end portion towards an indoor side,
wherein said pocket space has a depth dimension that is larger than a width dimension of the guide groove, and said outdoor sidewall of the guide rail has a bending strength that is larger than a bending strength of the slat end portion, and
wherein when a force enlarging a gap between the outdoor sidewall and the slat end portion acts upon the outdoor sidewall and the slat end portion, said slat end portion deforms in the pocket space before the outdoor sidewall deforms such that removal of the slat end portion from the guide groove is prevented by engaging the opening side front wall with the slat end portion being deformed in the pocket space.

2. The structure of claim 1, wherein a piece that is curved or diagonal in plan view is provided in a section of a guide rail internal space positioned at a bottom side and an indoor side of the internal space so as to devoid the internal space of a corner section.

3. The structure of claim 1, wherein a thinned portion is formed close to an end section of the opening side of the outdoor sidewall of the guide rail such that when a force acts, in a direction to open the outdoor sidewall, on the outdoor sidewall, the sidewall bends at the thinned portion.
